(19) United States
(12) Patent Application Publication
(10) Pub. No.: US 2001/0011508 A1
(43) Pub. Date: Aug. 9, 2001

(54) FLEXOGRAPHIC PRINTING MACHINE WITH A MULTIPLICITY OF INDIVIDUALLY DRIVEN PRINTING UNITS

(75) Inventor: WERNER THEUNER, TROISDORF (DE)

Correspondence Address: THE FIRM OF KARL F ROSS, 5676 RIVERDALE AVENUE, PO BOX 900, RIVERDALE (BRONX), NY, 10471-0900, US

(73) Assignee: LEMO MASCHINENBAU GMBH

(21) Appl. No.: 09/268,026

(22) Filed: Mar. 15, 1999

(30) Foreign Application Priority Data
Mar. 16, 1998 (DE) 198 11 134.7

(51) Int. Cl. B41F 13/54

(52) U.S. Cl. 101/228

(57) ABSTRACT

A flexographic printing machine for extensible webs like synthetic resin foil webs has a tension-measuring or length-measuring arrangement along the path through the multiplicity of printing units so as to control a web-drawing device at the downstream side of the path to ensure registry of the imprints or impressions produced by the printing units.

### FIELD OF THE INVENTION

My present invention relates to a flexographic printing machine having a multiplicity of individually driven printing units, especially for printing an extensible web of a material such as a synthetic resin foil which can change in length along the printing path. The invention also relates to a method of printing such a web and to a method operating a flexographic printing machine in the printing of such a web.

### BACKGROUND OF TUE INVENTION

By contrast with the printing of length-stable webs, such as webs of paper, where there is little difficulty in arranging driven printing units of a flexographic printing machine so that successively printed portions can be properly oriented with respect to one another, e.g. for registration of successively applied colors, in the processing or printing of elastic webs of material or webs which are only extensible, such as synthetic resin foil webs, problems can arise because of the more or less significant extensibility of the web in passing through the array of printing units. Successively applied imprints may become misaligned or out of registry. This is, of course, undesirable and is detrimental to the printing quality. The problem is compounded by the fact that the degree of elongation or extension of the web of material, e.g. the synthetic resin foil, can vary as a function of heating during traverse of the printing path or as a result of variations in the diameter of the guide and deflection rollers provided along the upstream of and downstream of the path and the relatively high fabrication tolerances in the diameters of such rollers.

### OBJECTS OF THE INVENTION

It is, therefore, the principal object of the present invention to provide an improved flexographic printing machine, especially of the type in which a multiplicity of individually driven printing units are traversed by an extensible web, whereby exact registry of successively printed images or impressions can be assured and hence a high printing quality can be maintained.

It is another object of this invention to provide a flexographic printing machine which avoids drawbacks of earlier systems used in the printing of extensible webs and especially synthetic resin foil webs.

Yet another object of the invention is to provide an improved method of printing a web, e.g. of a synthetic resin material, which is extensible and is subject to changes at least in its length dimension upon traversing the printing units of a flexographic printing machine.

Still another object of the invention is to provide an improved method of operating a flexographic printing machine to obviate the drawbacks measured previously.

### SUMMARY OF THE INVENTION

These objects and others which will become apparent hereinafter are attained, in accordance with the invention, by measuring the extensibility property of the material web, especially the synthetic resin foil, during its passage through the printing units of the flexographic printing machine by an appropriate measuring means and, through the use of a computer-controlled evaluation and control device which is operatively connected to the measuring means, controlling a web-withdrawal device at the downstream side of at least a part of the printing units to maintain a registry and, in particular, to compensate for changes in the length of the web as it traverses the array of printing units.

The measuring means can include at least one tension-measuring roller engaged with the synthetic resin foil and for which a setpoint value is provided. The predetermined setpoint value and the tension-measurement value can be compared with one another and can be maintained equal via the control of the unit pulling or drawing the web through the array of printing units. If the measured tension tends to be less, the withdrawal device can be driven more rapidly and when the tension becomes too great, the speed of the drawing can be reduced and the stretch of the synthetic resin foil web can be reduced.

Instead of a single tension-measuring roller, a plurality of tension measuring rollers can be used and in this case the first tension-measuring roller can be provided at the output side of at least the inlet group of printing units while the second tension-measuring roller can be provided at the upstream side of this group of printing units, between the latter and a pretensioning system.

In this case, the measured tension values are compared with one another and the foil-withdrawal device is so controlled that the tension in the web is held as constant as possible.

Instead of one or more tension-measuring rollers, the measuring means can include two measuring wheels which measure the incoming and outgoing lengths per unit time of the foil web and can be connected to a difference-forming control unit. The pulses outputted by the measurement wheels represent the incoming length and the outgoing length and are applied to the computer which, inter alia, forms the difference value between the pulse counts. The difference value can be used to control the drive unit of the withdrawal mechanism, advantageously via an amplifier or the like.

Independently of whether a tension measurement or a length measurement is used, the synthetic resin foil web travel through the flexographic printing machine is continuously monitored and deviations of the measured values from predetermined setpoints or deviations of measured values at a downstream location from that measured at an upstream location are used to maintain the elongation of the web substantially constant through at least the printing units.

More particularly, a flexographic printing machine for printing an extensible web can comprise:

a housing;

means for supplying the extensible web to a printing path in the housing;

a multiplicity of individually driven printing units arrayed along the path and traversed in succession by the extensible web;

a web-drawing unit along the path downstream of a last of the printing units and traversed by the web;

measuring means along the path responsive to a property of the material during the passage of the web along the path representing elongation along the path; and

a computer-controlled evaluation and regulating device operatively connected to the measuring means for controlling the web drawing unit in response to a degree of elongation of the web to maintain positioning of imprints by the printing units along the path.

A method of operating a flexographic printing machine can comprise:

(a) measuring a property of the web selected from changes in the length of web tension during passage of the web along the path; and

(b) controlling withdrawal of the web from the path in response to the property by comparison of a measured value with a predetermined setpoint for comparison between measured values at inlet and outlet portions of the path to maintain elongation of the path substantially constant.

The method of flexographic printing of the invention can comprise the steps of:

(a) passing the web along a printing path through a multiplicity of individually driven printing units of a flexographic printing machine arrayed along the path;

(b) measuring a property of the web representing a degree of elongation of the web along the path; and

(c) controlling a web-drawing unit engaging the web downstream of a last of the printing units along the path and driven by a computer control in response to the measured property to maintain positioning of imprints by the printing units along the path.

### BRIEF DESCRIPTION OF THE DRAWING

The above and other objects, features, and advantages will become more readily apparent from the following description, reference being made to the accompanying drawing in which:

FIG. 1 is an elevational view of a flexographic printing machine with a tension-measuring means shown in highly diagrammatic form;

FIG. 2 is a view similar to FIG. 1 showing the flexographic printing machine with length measurement by the measuring means;

FIG. 3 is a diagram of a control system as used for the arrangement of FIG. 1; and

FIG. 4 is a diagram of a control system for the arrangement of FIG. 2.

### SPECIFIC DESCRIPTION

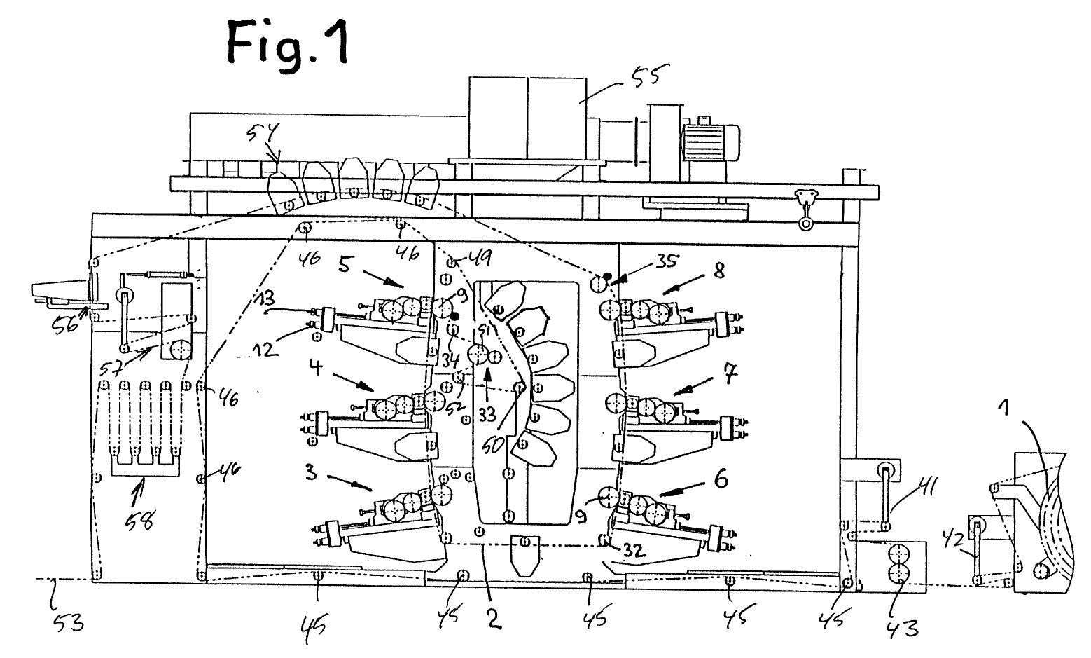

FIG. 1 shows an upright flexographic printing machine which has a delivery station 1 from which a web of material to be printed is paid out from a roller thereof, preferably in the form of a synthetic resin foil web 2. The foil can be fed via slack take-up devices 41 and 42 and the feed can be controlled by passing the foil between bridle rollers 43. The foil path along the bottom of the machine is formed by guide rollers 45 from which the web passes upwardly along additional guide rollers 46 to a pretensioning system formed by a guide roller 49, a loop-forming roller 50 and a feeding unit 51 which, together with a roller 52, forms a pretensioning unit 33.

The web then passes along a printing path formed by a multiplicity of, for example six, printing units 3,4, 5, 6, 7, 8 and then is ultimately delivered at 53 to a take-up station. Along the way, the foil can pass through printing ink dryers at 54 which can be ventilated by a blower system 55 before passing to an inspection station 56, through a further slack take-up station 57 and a station 58 for further treatment.

The printing units are all of identical construction and include the usual mechanisms and devices for printing, for example, grid or screen rolls, format cylinders, counter-pressure cylinders 9 on the opposite side of the foil web and the various drives required for these rollers, ink supplies and the like. The adjusting spindles for positioning the format cylinders and the screen roll have been shown diagrammatically at 12 and 13.

Each printing unit has its own drive with a servomotor and the servomotors are synchronized with one another via a drive control and an appropriate conductor network, the control system being computer-operated and having the usual system for monitoring, controlling and regulating the printing operation for registry of the applied printed impressions.

When the machine found in FIG. 1 is used for the flexographic printing of a synthetic resin foil web 2 which has a tendency to stretch, it can be equipped with a tension-measuring device. This tension-measuring device or means can comprise a first tension-measuring roller 32 in the region of the first printing unit 6 on the output side of the printing path, this output side having a group 6, 7, 8 of such printing units. A second tension-measuring sensor is provided in the form of a tension-measuring roller 34 at the inlet side of the first printing unit 5 of an upstream group of printing units 5, 4, 3 and between that first printing unit 5 and the pretensioning device 33.

The tension-measuring rollers 32 and 34 provide values of the tension in the foil web 2 passing around these rollers which can be compared and depending upon whether the measuring difference is positive or negative, can control a foil drawing device 35 downstream of the last printing unit 5, through the intermediary of a computer-controller evaluating system to slow or speed-up the withdrawal of the foil along the path.

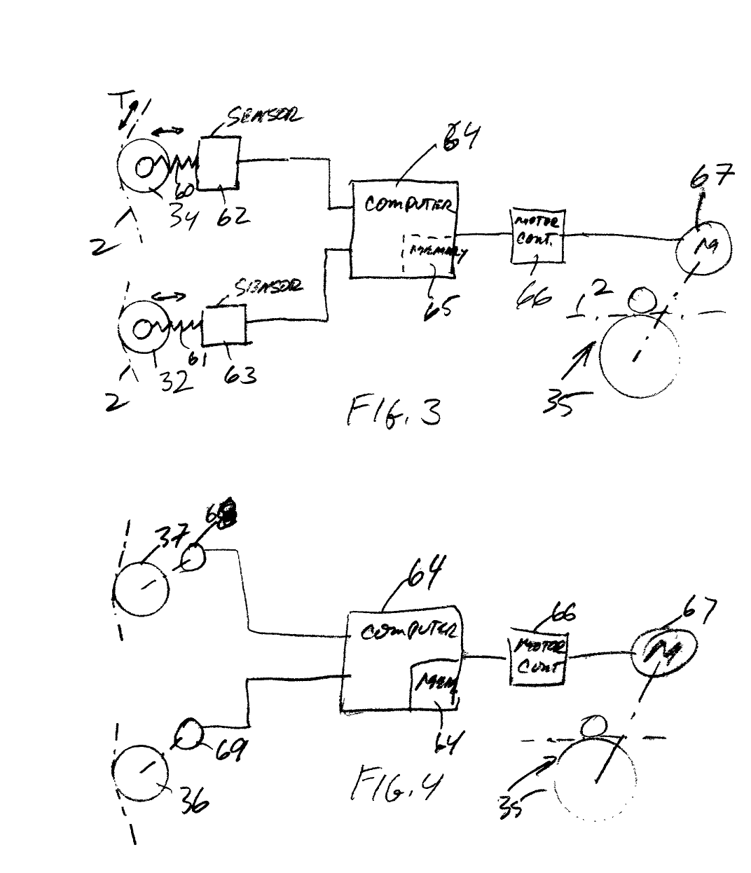

In FIG. 3 the tension-measuring rollers 32 and 34 are shown to be biased by springs 60 and 61 and to have positions detected by the sensors 62 and 63, these sensors detecting greater deflection of the respective roller 32, 34 as the tension T in the web increases. The difference in measurements is detected by the computer 64 which can have a memory 65 programmed to reflect the degree of elongation represented by the difference in sensor readings or with setpoint values, the computer output through a motor-controller/amplifier 66 being applied to a servomotor 67 driving the drawing device 35.

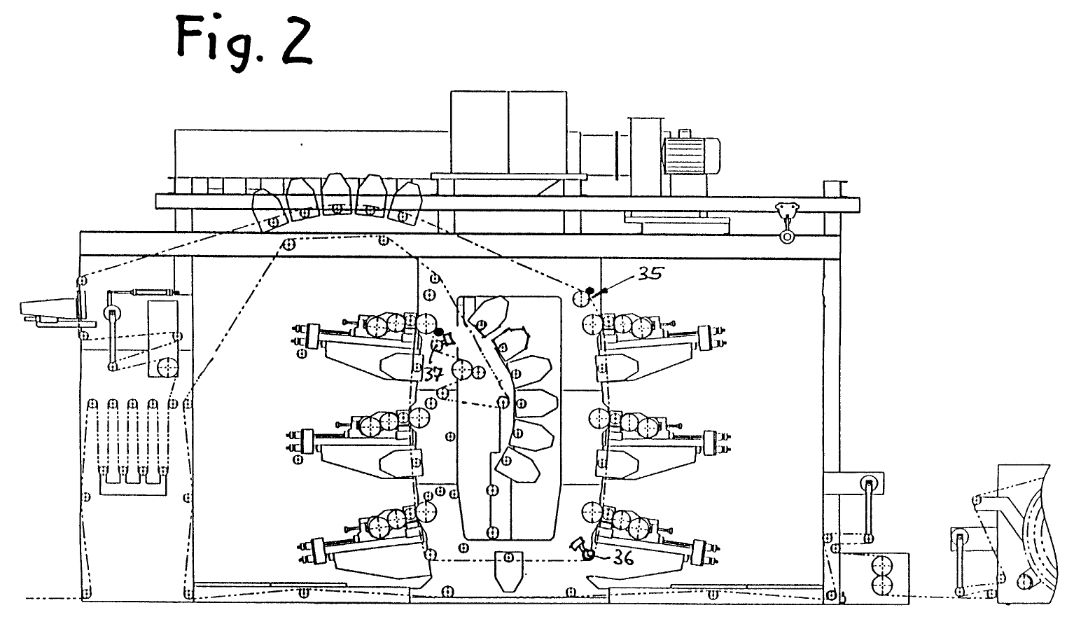

A similar result can be obtained with a system as shown diagrammatically in FIG. 2 wherein a length-measurement unit replaces the tension-measuring means of FIG. 1. Length measurements are made (per unit time) by measuring wheels 36, 37 which can be located generally at the same places as the wheels 32, 34 which have been described. As can be seen from FIG. 4, the wheels 36 and 37 associated with them and providing output pulses which are detected by a difference-forming unit here again constituted by the computer 64 to control the foil-drawing device 35. In this case, the pulses representing the incoming and outgoing lengths per unit time of the foil web are applied to a computer-control system. The inlet pulses might be positive and the outlet pulses negative so that upon combination of the outputs, a zero value can represent no length difference. The drawing device 35 can be regulated in the optimal case to maintain this condition or to maintain some other constant degree of elongation of the foil.

Before a production run is commenced, a nonextensible web, such as an aluminum foil strip, can be passed through the apparatus to calibrate it. In this manner any inaccuracies resulting from, for example mechanical tolerances, can be easily corrected by periodic resetting of the calibrated values. The tension improvement and the length measurement units can be also used for processing systems which have significant stretch in the web or which are composed of filaments which tend to stretch.

I claim:

1. A flexographic printing machine for printing a succession of imprints upon an extensible web of a material, said printing machine comprising:
a housing;
means for supplying said extensible web to a printing path in said housing;
a multiplicity of individually driven printing units arrayed along said path and traversed in succession by said extensible web;
a web-drawing unit along said path downstream of a last of said printing units and traversed by said web;
measuring means along said path responsive to a property of said material during the passage of said web along said path representing elongation along said path; and
a computer-controlled evaluation and regulating device operatively connected to said measuring means for controlling said web drawing unit in response to a degree of elongation of said web to maintain positioning of imprints by the printing units along said path.

2. The flexographic printing machine defined in claim 1 wherein said measuring means includes at least one tension-measuring roller engaged with said web.

3. The flexographic printing machine defined in claim 2 wherein said measuring means includes a first tension-measuring roller engageable with said web upstream of an output-side group of said printing units and a second tension-measuring roller engageable with said web at an upstream side of an inlet group of said printing units between said inlet group and a pretensioning unit provided on said housing.

4. The flexographic printing machine defined in claim 1 wherein said measuring means includes measuring rollers for measuring the incoming length of said web at an upstream side of at least a group of said printing units and another measuring roller measuring the output length of said web at the downstream side of said group, said computer including means responsive to a difference between values outputted by said measuring rollers.

5. A method of printing an extensible web of a material which comprises the steps of:
(a) passing said web along a printing path through a multiplicity of individually driven printing units of a flexographic printing machine arrayed along said path;
(b) measuring a property of said web representing a degree of elongation of said web along said path; and
(c) controlling a web-drawing unit engaging said web downstream of a last of said printing units along said path and driven by a computer control in response to the measured property to maintain positioning of imprints by the printing units along said path.

6. The method defined in claim 5 wherein said property is a tension in said web.

7. The method defined in claim 6 wherein tension in said web is measured at a location upstream of an output group of said printing units and at a location upstream of an input group of said printing units by respective tension-measuring rollers are supplied to a computer controlling said web-drawing device.

8. The method defined in claim 5 wherein input and output lengths of said web are measured at opposite sides of at least a group of said printing units in a measurement of said property.

9. A method of operating a flexographic printing machine for the flexographic printing of an extensible web in the form of a synthetic resin foil and in which the web is passed along a printing path through a succession of individually driven printing units, the improvement which comprises the steps of:
(a) measuring a property of said web selected from changes in the length of web tension during passage of said web along said path; and
(b) controlling withdrawal of said web from said path in response to said property by comparison of a measured value with a predetermined setpoint for comparison between measured values at inlet and outlet portions of said path to maintain elongation of said path substantially constant.
